(19) United States
(12) Patent Application Publication
(10) Pub. No.: US 2006/0077141 A1
(43) Pub. Date: Apr. 13, 2006

(54) Current sample/hold circuit and display device using the same, and display panel and driving method thereof

(76) Inventor: Oh-Kyong Kwon, Suwon-si (KR)

Correspondence Address: CHRISTIE, PARKER & HALE, LLP, PO BOX 7068, PASADENA, CA, 91109-7068, US

(21) Appl. No.: 11/228,754

(22) Filed: Sep. 15, 2005

(30) Foreign Application Priority Data
Oct. 8, 2004 (KR) 10-2004-0080369

(51) Int. Cl. G09G 3/30

(52) U.S. Cl. 345/77

(57) ABSTRACT

A display device including a display unit including data lines for transmitting data currents, scan lines for transmitting scan signals, and pixel areas defined by the data lines and the scan lines. The display device includes a data driver for converting a plurality of grayscale data into data currents and for applying the data currents to the data lines. and a scan driver for sequentially applying the scan signals to the scan lines. The data driver includes a first current generator for generating first currents and D/A converters for using the first currents to output the data currents corresponding to the grayscale data, the first currents being different from each other. Each D/A converter includes current sample/hold circuits for storing first voltages corresponding to the first currents in at least two capacitors and for outputting second currents corresponding to the first voltages in response to the grayscale data.

### CROSS-REFERENCE TO RELATED APPLICATION

This application claims priority to and the benefit of Korean Patent Application No. 10-2004-0080369 filed in the Korean Intellectual Property Office on Oct. 8, 2004, the entire content of which is incorporated herein by reference.

### FIELD OF THE INVENTION

The present invention relates to a display device. More particularly, the present invention relates to a display device using a current sample/hold circuit, and a display panel of the display device and a driving method of the same.

### BACKGROUND OF THE INVENTION

In general, a light emitting display device is a display using electric field light emission of organic materials, which displays an image by driving N×M organic light emitting pixels in a voltage driving method or a current driving method. In the light emitting display device, the N×M organic light emitting pixels are arranged in a matrix format.

An organic light emitting pixel includes an anode, an organic thin film, and a cathode.

The organic thin film is formed as a multi-layered structure including an emission layer (EML), an electron transport layer (ETL), and a hole transport layer (HTL) so as to increase luminescence efficiency by balancing electron and hole concentrations. In addition, it may separately include an electron injection layer (EIL) and a hole injection layer (HIL).

According to an addressing method, methods for driving the light emitting display device may be classified into a passive matrix method and an active matrix method using thin film transistors (TFTs) or metal-oxide semiconductor field-effect transistors (MOSFETs).

In the passive matrix method, the organic light emitting pixels are formed between anode lines and cathode lines perpendicularly crossing each other, and are driven by selecting the respective lines. However, in the active matrix method, a thin film transistor is coupled to each pixel electrode, and the organic light emitting pixels are driven according to a voltage maintained by capacitance of a capacitor coupled to a gate of the thin film transistor.

Further, depending on formats of signals applied to the capacitor for maintaining the voltage after programming the voltage to the capacitor, the active matrix method may be categorized as a voltage programming method or a current programming method.

However, it is difficult to obtain high grayscales using pixel circuits according to the voltage programming method because of deviations of threshold voltage and electron mobility of thin film transistors, the deviations being caused by non-uniformity of a manufacturing process.

In the current programming method, however, uniform display characteristics can be achieved even though driving transistors in each pixel have non-uniform voltage-current characteristics, provided that a current source for supplying the current to the pixel is uniform throughout the whole panel (i.e., all the data lines).

Realization of a display device by using the pixel circuit that employs the current programming method requires an additional grayscale current generation circuit to convert grayscale data into grayscale currents to be applied to pixels.

The above information disclosed in this Background of the Invention section is only for enhancement of understanding of the background of the invention and therefore, unless explicitly described to the contrary, it should not be taken as an acknowledgment or any form of suggestion that this information forms the prior art that is already known in this country to a person of ordinary skill in the art.

### SUMMARY OF THE INVENTION

The present invention provides a display device using a grayscale current generation circuit utilizing a current sample/hold circuit, a display device and a display panel utilizing such a grayscale current generation circuit, and a method for driving the same.

In an exemplary embodiment according to the present invention, a display device includes a display unit, a data driver, and a scan driver. The display unit includes a plurality of data lines for, transmitting data currents, a plurality of scan lines for transmitting scan signals, and a plurality of pixel areas defined by the data lines and the scan lines. The data driver converts a plurality of grayscale data into data currents and applies the data currents to the data lines. The scan driver sequentially applies the scan signals to the plurality of scan lines.

The data driver includes a first current generator for generating a plurality of first currents and a plurality of digital/analog (D/A) converters for using the plurality of first currents to output the data currents corresponding to the grayscale data, the plurality of first currents being different from each other. Each of the D/A converters includes a plurality of current sample/hold circuits for storing first voltages corresponding to the plurality of first currents in at least two capacitors and for outputting second currents corresponding to the first voltages in response to the grayscale data.

In a further embodiment, a display device includes a display unit, a first shift register, a latch, a grayscale current generator, and an output unit.

The display unit includes a plurality of data lines for transmitting data currents, a plurality of scan lines for transmitting scan signals, and a plurality of pixel areas defined by the data lines and the scan lines. The first shift register generates a plurality of second signals by sequentially delaying a first signal for a period. The latch latches a plurality of grayscale data in synchronization with the second signals. The grayscale current generator receives the plurality of grayscale data and outputs the data currents corresponding to the grayscale data. The output unit applies the data currents output from the grayscale current generator to the plurality of data lines.

The grayscale current generator includes a bias current generator for generating a plurality of bias currents and a plurality of D/A converters for using the plurality of bias currents to output the data currents corresponding to the grayscale data. The plurality of bias currents are different from each other. Each of the D/A converters include a plurality of current sample/hold circuits for storing first voltages corresponding to the bias currents in at least two capacitors, and for outputting currents corresponding to the first voltages in response to the grayscale data.

In another further embodiment, a current sample/hold circuit for sampling and holding a first current is provided. The current sample/hold circuit includes first and second transistors, first and second capacitors, a first switch, and a second switch. The first and second transistors each has first, second and third electrodes, and are cascade-connected to a power source, and are diode-connected in response to a first control signal. The first and second capacitors are respectively coupled between the first electrodes of the first and second transistors and the power source. The first switch applies the first current to the first and second transistors in response to a second control signal. The second switch is coupled to the third electrode of the second transistor, and holds a current flowing to the second transistor in response to a third control signal.

In another further embodiment, a driving method of a display panel having a plurality of pixels for displaying an image corresponding to data currents, is provided. The method includes generating a plurality of first currents that are different from each other, sampling the first currents, respectively storing a plurality of first voltages corresponding to the first currents in at least two capacitors, respectively outputting a plurality of second currents corresponding to the plurality of first voltages in response to grayscale data, and adding the plurality of second currents and outputting a sum of the second currents as at least one of the data currents.

### BRIEF DESCRIPTION OF THE DRAWINGS

FIG. 1 is a top plan view that schematically illustrates an organic light emitting diode (OLED) display according to an exemplary embodiment of the present invention.

FIG. 2 is a block diagram illustrating a data driver according to an exemplary embodiment of the present invention.

FIG. 3 is a block diagram illustrating a grayscale current generator according to an exemplary embodiment of the present invention.

FIG. 4 illustrates a current sample/hold circuit according to a first exemplary embodiment of the present invention.

FIG. 5 illustrates a digital/analog (D/A) converter using the current sample/hold circuit according to the first exemplary embodiment of the present invention.

FIG. 6 illustrates a current sample/hold circuit according to a second exemplary embodiment of the present invention.

FIG. 7 illustrates a current sample/hold circuit according to a third exemplary embodiment of the present invention.

FIG. 8 illustrates a D/A converter using the current sample/hold circuit according to the third exemplary embodiment of the present invention.

### DETAILED DESCRIPTION

In the following detailed description, a connection between one part to another may refer to a direct connection between them, or an electrical connection via a third device or part.

The drawings and description are to be regarded as illustrative in nature and not restrictive.

Like reference numerals designate like elements throughout the specification.

In addition, a type of currents is changed according to a type of a first driving part when the current is output from the first driving part to a second driving part. In other words, the output current of the first driving part flows from the first driving part to the second driving part when the first driving part is a source-type driver, but the output current of the first driving part flows from the second driving part to the first driving part when the first driving part is a sink-type driver.

A display device and a driving method thereof according to exemplary embodiments of the present invention will now be described in more detail with reference to the accompanying drawings.

Throughout the embodiments of the present invention, a display device that uses electro-luminescence of an organic material will be described as a light emitting display device.

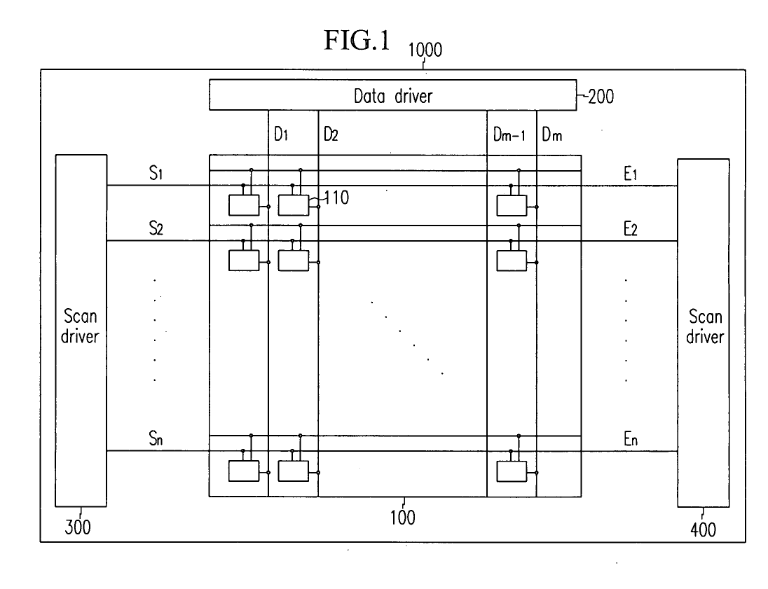

FIG. 1 is a top plan view that schematically illustrates an organic light emitting diode (OLED) display according to an exemplary embodiment of the present invention.

As shown in FIG. 1, the OLED display includes a substrate 1000 for forming a display panel, and the substrate 1000 includes a display unit 100 for displaying an actual image and a driving part.

The driving part includes a data driver 200, and scan drivers 300 and 400.

The display unit 100 includes a plurality of data lines D1-Dm, a plurality of scan lines S1-Sn, a plurality of light emission control lines E1-En, and a plurality of pixels 110.

The data lines D1-Dm are arranged in a column direction, and transmit data currents for an image to the pixels 110.

The scan lines S1-Sn and the light emission control lines E1-En are arranged in a row direction, and respectively transmit scan signals and light emission control signals to the pixels.

A pixel area is defined by one data line and one scan line.

The data driver 200 applies data currents to the data lines D1-Dm.

The scan driver 300 sequentially applies the scan signals to the plurality of scan lines S1-Sn, and the scan driver 400 sequentially applies the light emission control signals to the plurality of light emission control lines E1-En.

The data driver 200 and/or the scan drivers 300 and 400 may be coupled to the substrate 1000 using one or more various different schemes. By way of example, they may be realized in a form of a chip so as to be installed to various types of electrical connection members, such as a tape carrier package (TCP), a flexible printed circuit, and/or a film.

Alternatively, the data driver 200 and/or the scan drivers 300 and 400 may be directly attached to the substrate 1000 of the display unit, and they may be realized as a driving circuit that is formed on the substrate and has a layer structure similar to data lines D1-Dm, scan lines S1-Sn and E1-En, and transistors of a pixel circuit.

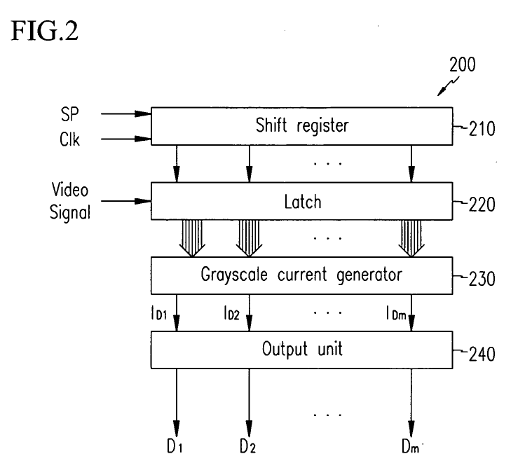

FIG. 2 is a block diagram illustrating a data driver 200 according to an exemplary embodiment of the present invention.

As shown in FIG. 2, the data driver 200 includes a shift register 210, a latch 220, a grayscale current generator 230, and an output unit 240.

The shift register 210 sequentially shifts a start signal SP to output sequentially shifted start signals in synchronization with a clock signal Clk.

The latch 220 latches a video signal and outputs a latched video signal in synchronization with an output signal of the shift register 210.

The grayscale current generator 230 receives an output video signal of the latch 220 and generates grayscale currents I_{D1}-I_{Dm} that correspond to the video signal.

The output unit 240 applies the grayscale currents I_{D1}-I_{Dm} received from the grayscale current generator 230 to the data lines D1-Dm.

The output unit 240 may be provided as buffer circuits coupled between output terminals of the grayscale current generator 230 and the data lines D1-Dm, respectively.

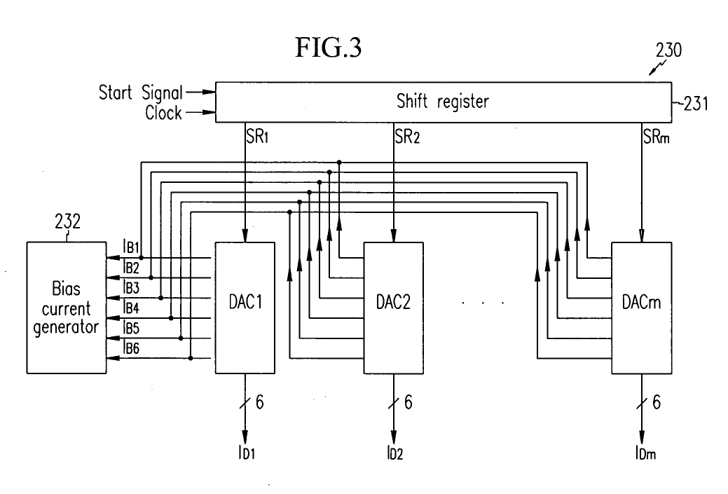

A grayscale current generator according to an exemplary embodiment of the present invention will now be described with reference to FIGS. 3, 4 and 5.

In the following embodiments, a video signal is assumed to be a 6-bit grayscale data, for ease of description. The video signal, however, is not limited to 6 bits and may have any other suitable number of bits.

FIG. 3 is a block diagram illustrating a grayscale current generator 230 according to an exemplary embodiment of the present invention.

As shown in FIG. 3, the grayscale current generator 230 includes a shift register 231, a bias current generator 232, and a plurality of digital/analog (D/A) converters DAC1-DACm. In FIG. 3, the bias current generator 232 is set to be a sink-type bias current generator. In other embodiments, the bias current generator may be a source-type bias current generator.

The shift register 231 sequentially shifts a start signal in synchronization with a clock signal such that the respective D/A converters DAC1-DACm sequentially input bias currents I_{B1}-I_{B6}.

The bias current generator 232 generates the bias currents I_{B1}-I_{B6} corresponding to a bit number of the grayscale data and outputs the generated bias currents to the D/A converters DAC1-DACm. Since, the bias current generator 232 is a sink-type bias current generator, the bias currents I_{B1}-I_{B6} flow from the D/A converters DAC1-DACm to the bias current generator 232. However, the bias current generator 232 may still be said to output the bias currents and the D/A converters DAC1-DACm may be said to input the bias currents.

According to an exemplary embodiment of the present invention, the bias current I_{B2} is set to be substantially equal to twice the bias current I_{B1}, and the bias currents I_{B3}-I_{B6} are set to be substantially equal to 4 times, 8 times, 16 times and 32 times that of the bias current I_{B1}, respectively.

The D/A converters DAC1-DACm convert the grayscale data into grayscale currents in synchronization with output signals SR1-SRm of the shift register 231.

In addition, the respective D/A converters DAC1-DACm include a number of current sample/hold circuits that correspond to the bit number of the grayscale data.

In the case where the grayscale data is set to be 6 bit data, one D/A converter (e.g., DACm) includes 6 current sample/hold circuits, and the respective sample/hold circuits sample and hold the bias currents I_{B1}-I_{B6} and output currents I_{outm[0]}-I_{outm[5]} in response to respective bits of the grayscale data.

The D/A converter (e.g., DACm) adds all the output currents I_{outm[0]}-I_{outm[5]} of the 6 current sample/hold circuits as one grayscale current (e.g., I_{Dm}) and outputs the grayscale current (e.g., I_{Dm}).

The following description will be focused on the 6-bit grayscale data, but it should not be understood that the present invention is limited thereto.

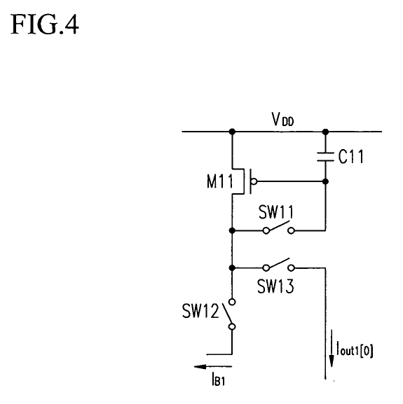

FIG. 4 shows one of the 6 sample/hold circuits of the D/A converters DAC1-DACm. For ease of description, the sample/hold circuit of FIG. 4 will be described in reference to a lowest significant bit (i.e., a first bit) sample/hold circuit of DAC1. It outputs a current Iout1[0] corresponding to a first grayscale data according to a first exemplary embodiment of the present invention.

As shown in FIG. 4, the current sample/hold circuit includes a transistor M11, a capacitor C11, and switches SW11, SW12 and SW13.

The transistor M11 is a P-type channel MOS (e.g., PMOS), and a source thereof is coupled to a power source VDD.

The capacitor C11 is coupled between a gate and the source of the transistor M11.

The switch SW11 is coupled between a drain and the gate of the transistor M11, and is turned on in response to an output signal SR1 of the shift register 231.

The switch SW12 is coupled between an output terminal of the bias current generator 232 and the drain of the transistor M11, and is turned on in response to the output signal SR1 of the shift register 231.

The switch SW13 is coupled between the drain of the transistor M11 and the output terminal of the sample/hold circuit, and is turned on in response to a first bit of the grayscale data.

Thus, when the output signal SR1 is input from the shift register 231, the switch SW11 is turned on and the transistor M11 is diode-connected.

As a result, the switch SW12 is turned on, the bias current I_{B1} flows through the transistor M11, and a voltage corresponding to the bias current I_{B1} is stored in the capacitor C11.

Subsequently, the first grayscale data is applied to the switch SW13, and the switch SW13 is turned on when the first bit of the first grayscale data is 1.

Consequently, the current Iout1[0] that corresponds to the voltage stored in the capacitor C11 flows to the output terminal of the sample/hold circuit through the transistor M11.

When the first bit of the first grayscale data is 0, the switch SW13 is turned off and the current from the transistor M11 is cut off.

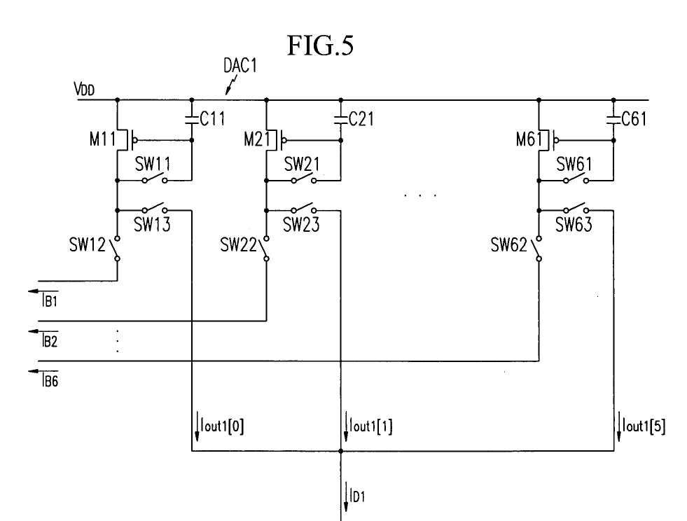

FIG. 5 illustrates the D/A converter DAC1 including the 6 current sample/hold circuits of FIG. 4. While the D/A converter of FIG. 5 is labeled as DAC1, the D/A converter of FIG. 5 can represent any of a plurality of D/A converters DAC1-DACm.

As described, since the grayscale data is set to be 6 bits in the first exemplary embodiment of the present invention, the D/A converter DAC1 includes 6 current sample/hold circuits.

In more detail, when the output signal SR1 is applied from the shift register 231, switches SW11-SW61 and SW12-SW62 of the respective current sample/hold circuits are turned on.

As a result, transistors M11-M61 are diode-connected and the bias currents I_{B1}-I_{B6} flow through the transistors M11-M61, and thus voltages that correspond to the respective bias currents I_{B1}-I_{B6} are stored in capacitors C11-C61, respectively.

When respective bits of the grayscale data are applied to switches SW13-SW63 of the respective current sample/hold circuits, the current sample/hold circuits respond to the grayscale data and the current Iout1[0]-Iout1[5] corresponding to the voltages stored in the capacitors C11-C61 are output through the output terminal.

For example, when the grayscale data is 001010, the switches SW23, SW43 of the second and fourth current sample/hold circuits from the left in FIG. 5 are turned on and the current Iout1[1], Iout1[3] corresponding to the voltages stored in the capacitors C21, C41 are output.

The two output currents Iout1[1], Iout1[3] are added as one grayscale current I_{D1}.

FIG. 5 illustrates the D/A converter DAC1 only, but the plurality of D/A converters DAC2-DACm operate the same as the D/A converter DAC1.

In other words, when the output signals SR2-SRm from the shift register 231 are sequentially input to the D/A converters DAC2-DACm, the 6 current sample/hold circuits of the respective D/A converters DAC2-DACm respectively output currents Iout2[0]-Iout2[5] to Ioutm[0]-Ioutm[5]0 corresponding to the grayscale data and the D/A converters DAC2-DACm respectively add the currents Iout2[0]-Iout2[5] to Ioutm[0]-Ioutm[5] and respectively output currents I_{D2}-I_{Dm}.

In addition, the D/A converter outputs the 6 bias currents I_{B1}-I_{B6} generated by the bias current generator 232 to the 6 current sample/hold circuits respectively, and the 6 bias currents I_{B1}-I_{B6} respectively correspond to the bits of the grayscale data, according to the first exemplary embodiment of the present invention.

Thus, deviation of holding currents due to characteristics of the transistors (M11-M61) may be prevented compared to when inputting one bias voltage or one bias current and outputting a plurality of different currents.

In other words, currents output from the respective current sample/hold circuits may be set to be different from each other by using one bias voltage or one bias current and controlling widths and lengths of channels of the transistors M11-M61. In this case, however, a desired current may not be output due to deviation of the transistors M11-M61.

The current deviation due to the transistors M11-M61 may be prevented by setting characteristics of the transistors M11-M61 included in the respective current sample/hold circuits to be substantially equivalent to each other and transmitting a plurality of bias currents generated by the bias current generator 232 to the respective current sample/hold circuits according to the first exemplary embodiment of the present invention.

However, a manufacturing process of the transistors M11-M61 may result in deviation between output currents even when using the current sample/hold circuits according to the first exemplary embodiment of the present invention.

In other words, when the bias currents I_{B2}-I_{B6} are set to be a power of 2 times the bias current I_{B1}, output currents of the second to sixth current sample/hold circuits may not be a power of 2 times the output current of the first current sample/hold circuit. As a result, an output current may not be a desired grayscale current.

To solve the foregoing problem, two transistors are cascade-connected to reduce the deviation of the output currents of the sample/hold circuits due to the transistor manufacturing process according to a second exemplary embodiment of the present invention.

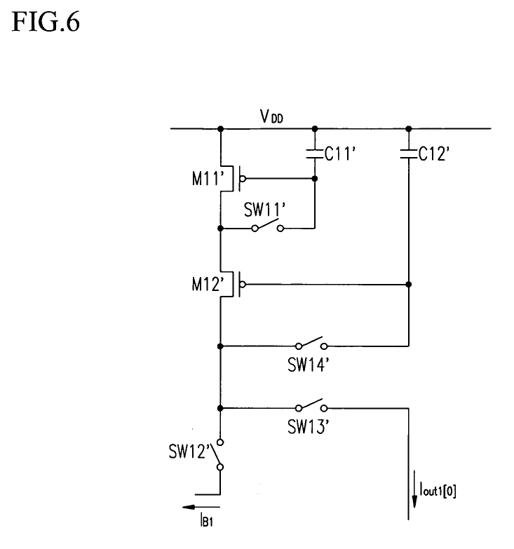

FIG. 6 illustrates a current sample/hold circuit according to the second exemplary embodiment of the present invention.

Similar to FIG. 4, FIG. 6 illustrates one of current sample/hold circuits included in a D/A converter DAC1′. It outputs a current Iout1[0] corresponding to first grayscale data. By way of example, the D/A converter DAC1′ may be used as any one of the D/A converters DAC1 to DACm of FIG. 3. However, for ease of description, the D/C converter DAC1′ of FIG. 4 will be described in reference to the D/A converter that receives the output signal SR1.

As shown in FIG. 6, the current sample/hold circuit includes components that are similar to those of the current sample/hold circuit in the first exemplary embodiment, but the current sample/hold circuit in the second exemplary embodiment further includes a transistor M12′, a switch SW14′, and a capacitor C12′, differing from the current sample/hold circuit in the first exemplary embodiment.

In more detail, the transistor M12′ is coupled between a transistor M11′ and a switch SW12′, and the capacitor C12′ is coupled between a gate of the transistor M12′ and a power source VDD.

The switch SW14′ is coupled between the gate and a drain of the transistor M12′ and is turned on in response to an output signal SR1 of the shift register 231.

A sum of capacitances of the capacitors C11′ and C12′ is set to be substantially equivalent to the capacitance of the capacitor C11 of FIG. 4.

In other words, a sum of voltages stored in the capacitors C11′ and C12′ is set to be substantially equivalent to the voltage stored in the capacitor C11 of the first exemplary embodiment according to the present invention.

Thus, when the output signal SR1 is applied from the shift register 231, the switches SW11′, SW14′ are turned on and the transistors M11′, M12′ are diode-connected, and the switch SW12′ is turned on and the bias current I_{B1} flows through the transistors M11′, M12′.

Therefore, voltages that respectively correspond to the bias current I_{B1} flowing through the respective transistors M11′, M12′ are stored in the capacitors C11′, C12′.

When the grayscale data is applied to the switch SW13′ and thus the switch SW13′ is turned on, the transistors M11′, M12′ output currents respectively corresponding to the voltages respectively stored in the capacitors C11′ and C12′.

A current Iout1[0] output from the current transistors M11′, M12′ is output to an output terminal of the sample/hold circuit through the switch SW13′.

Here, since a sum of the capacitances of the capacitors C11′ and C12′ is substantially equivalent to the capacitance of the capacitor C11 of FIG. 4, a sum of the currents held by the capacitors C11′, C12′ is substantially equivalent to the current held by the capacitor C11 of FIG. 4.

As described, the two transistors M11′, M12′ are cascade-connected and the voltages corresponding to the currents flowing to the respective transistors M11′, M12′ are separately stored in the capacitors C11′ and C12′, and thus a deviation of holding currents due to the deviation of characteristics of the transistors included in the 6 current sample/hold circuits may be reduced according to the second exemplary embodiment of the present invention.

Consequently, grayscale data may be more accurately converted into grayscale currents.

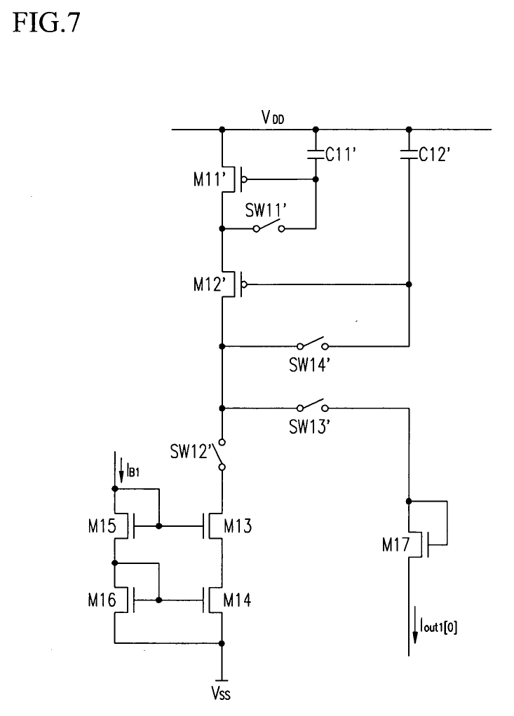

FIG. 7 illustrates a current sample/hold circuit according to a third exemplary embodiment of the present invention. A bias current generator for supplying bias currents to the current sample/hold circuit of FIG. 7 is set to be a source-type bias current generator, differing from the bias current generator of FIG. 3.

As shown in FIG. 7, the current sample/hold circuit of the third exemplary embodiment inputs a bias current by using a current mirror circuit, differing from the current sample/hold circuit of the second exemplary embodiment.

In other words, a current flowing through transistors M15, M16 is mirrored and transmitted through transistors M13, M14 by the current sample/hold circuit when the switch SW12′ is turned on. The transistors M13, M14, M15 and M16 are illustrated as N-type channel MOS (e.g., NMOS). but different types of suitable transistors may be used in other embodiments.

When inputting the bias current input by using the current mirror circuit, a diode-connected transistor M17 may be additionally coupled between the switch SW13′ and the output terminal of the current sample/hold circuit.

In this case, voltages between drains and sources of the respective transistors M11′, M12′ may be different from each other depending on a load difference generated when the transistors M13, M14 and the transistors M11′, M12′ are electrically coupled and decoupled by the switch SW12′.

Thus, the transistor M17 is coupled between the switch SW13′ and the output terminal of the current sample/hold circuit to reduce the load difference generated when the transistors M13, M14 and the transistors M11′, M12′ are electrically coupled and decoupled by the switch SW12′ to thereby prevent the voltages between the drains and the sources of the respective transistors M11′, M12′ from being different from each other.

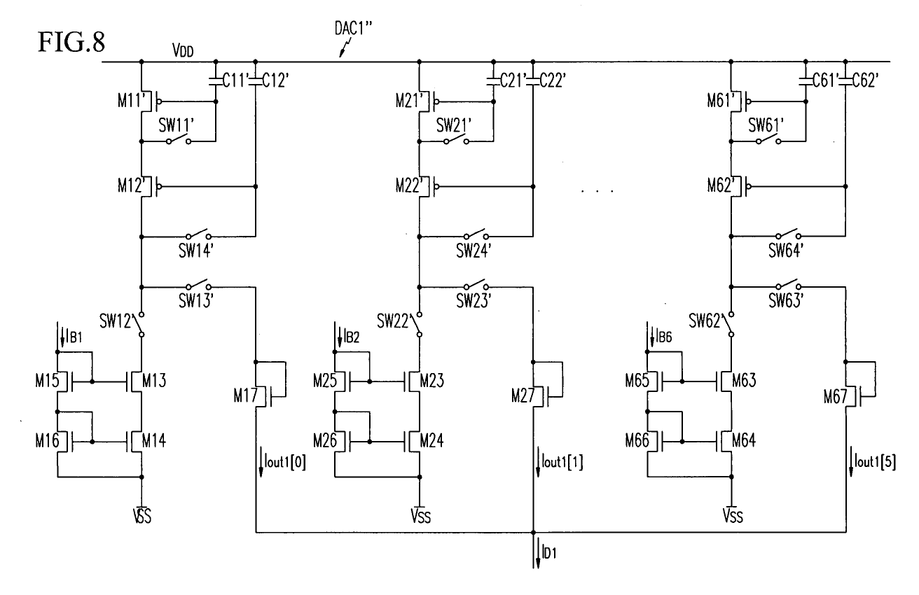

FIG. 8 illustrates a D/A converter DAC1″ using the current sample/hold circuit of FIG. 7. As can be seen in FIG. 8, the sample/hold circuits of the D/A converter DAC1″ respectively include switches SW11′, SW21′ through SW61′, switches SW12′, SW22′ through SW62′, switches SW13′, SW23′ through SW63′, and switches SW14′, SW24′ through SW64′. Further, the sample/hold circuits respectively include current mirror circuits including transistors M13-M16, M23-M26 through M63-M66, and respectively include diode-connected transistors M17, M27 through M67.

As shown in FIG. 8, the D/A converter DAC1″ includes 6 current sample/hold circuits, and the respective current sample/hold circuits sample bias currents I_{B1}-I_{B6} input by a current mirror circuit, and output currents corresponding to voltages respectively stored in the capacitors C11′, C12′, C21′, C22′ through C61′, C62′ in response to respective bits of grayscale data.

As a result, grayscale currents corresponding to the grayscale data may be output, and deviations of characteristics of transistors included in a plurality of current sample/hold circuits may be reduced by separately storing voltages that correspond to the bias currents in two capacitors by cascade-connecting two transistors (e.g., M11′, M12′, M21′, M22′ through M61′, M62′).

According to the present invention, a plurality of current sample/hold circuits may be used to generate grayscale currents corresponding to grayscale data.

In addition, the bias current generator of the grayscale current generation circuit generates a plurality of different bias currents and applies the different bias currents to the respective current sample/hold circuits to thereby reduce deviation of the holding current due to the deviation of the transistors of the current sample/hold circuit.

Further, a plurality of transistors are cascade-connected and voltages corresponding to the respective bias currents are separately stored in at least two capacitors to thereby reduce deviation of holding currents between the respective current sample/hold circuits.

The above described embodiments are merely examples of the present invention. This implies that the present invention is not limited to the disclosed embodiments and it may cover various modifications.

For example, FIG. 4 to FIG. 8 illustrate some of the transistors as a P-type channel MOS (e.g., PMOS) and others as an N-type channel MOS (e.g., NMOS), but the transistors may be provided as N-type channel MOS or P-type channel MOS, respectively, that are different from the illustrated transistors, or be formed using different active switches having first, second, and third electrodes and outputting a current that corresponds to a voltage applied between the first and second electrodes through the third electrode.

In addition, while FIG. 6 to FIG. 8 illustrate that two transistors are cascade-connected to a power source VDD, and two capacitors are respectively coupled between gates of the two transistors and the power source VDD, more than three transistors may be cascade-connected to the power source VDD and more than three capacitors may be respective coupled between gates and the power source VDD of the respective transistors according to another embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A display device comprising:
a display unit including a plurality of data lines for transmitting data currents, a plurality of scan lines for transmitting scan signals, and a plurality of pixel areas defined by the data lines and the scan lines;
a data driver for converting a plurality of grayscale data into data currents and for applying the data currents to the data lines; and
a scan driver for sequentially applying the scan signals to the plurality of scan lines,
wherein the data driver comprises a first current generator for generating a plurality of first currents and a plurality of digital/analog (D/A) converters for using the plurality of first currents to output the data currents corresponding to the grayscale data, the plurality of first currents being different from each other, and
wherein each of the D/A converters comprises a plurality of current sample/hold circuits for storing first voltages corresponding to the plurality of first currents in at least two capacitors and for outputting second currents corresponding to the first voltages in response to the grayscale data.

2. The display device of claim 1, wherein at least one of the current sample/hold circuits comprises:
a first transistor and a second transistor, each having first, second and third electrodes, the first and second transistors being cascade-connected to a power source;
a first switch and a second switch for respectively diode-connecting the first and second transistors in response to a first control signal;
a third switch for applying a corresponding one of the first currents to the first and second transistors in response to a second control signal; and
a fourth switch for outputting a corresponding one of the second currents in response to the grayscale data,
wherein the at least two capacitors are respectively coupled between the first electrodes of the first and second transistors and the power source.

3. The display device of claim 2, wherein the at least one of the current sample/hold circuits further comprises a current mirror circuit for mirroring the corresponding one of the first currents, and
wherein the third switch transmits a current mirrored by the current mirror circuit to the first and second transistors in response to the second control signal.

4. The display device of claim 3, wherein the at least one of the current sample/hold circuits further comprises a diode coupled to the fourth switch.

5. The display device of claim 2, wherein
the first and second transistors are MOS transistors, each having a gate, a source and a drain as the first, second and third electrodes, respectively.

6. The display device of claim 2, wherein the first and second control signals are substantially equivalent to each other.

7. The display device of claim 1, wherein the data driver further comprises a shift register for generating a plurality of second signals by sequentially delaying a first signal for a period and for sequentially applying the plurality of second signals to the plurality of D/A converters.

8. The display device of claim 7, wherein the current sample/hold circuits store the first voltages corresponding to the plurality of first currents in response to the second signals, and output the second currents corresponding to the first voltages in response to the grayscale data.

9. The display device of claim 8, wherein each of the current sample/hold circuits outputs a corresponding one of the second currents in response to a corresponding bit of the grayscale data.

10. A display device comprising:
a display unit including a plurality of data lines for transmitting data currents, a plurality of scan lines for transmitting scan signals, and a plurality of pixel areas defined by the data lines and the scan lines;
a first shift register for generating a plurality of second signals by sequentially delaying a first signal for a period;
a latch for latching a plurality of grayscale data in synchronization with the second signals;
a grayscale current generator for receiving the plurality of grayscale data and for outputting the data currents corresponding to the grayscale data; and
an output unit for applying the data currents output from the grayscale current generator to the plurality of data lines,
wherein the grayscale current generator comprises a bias current generator for generating a plurality of bias currents and a plurality of digital/analog (D/A) converters for using the plurality of bias currents to output the data currents corresponding to the grayscale data, the plurality of bias currents being different from each other, and
wherein each of the D/A converters comprises a plurality of current sample/hold circuits for storing first voltages corresponding to the bias currents in at least two capacitors, and for outputting currents corresponding to the first voltages in response to the grayscale data.

11. The display device of claim 10, wherein the grayscale current generator further comprises a second shift register for generating a plurality of fourth signals by sequentially delaying a third signal, and
wherein the D/A converters are applied with the bias currents in synchronization with the fourth signals.

12. The display device of claim 10, wherein the grayscale current generator further comprises a second latch for generating the data currents by adding the bias currents held by the current sample/hold circuits of at least one of the D/A converters, and for latching the data currents and outputting the latched data currents.

13. A grayscale current generator for generating a grayscale current based on input grayscale data, comprising a plurality of digital/analog (D/A) converters,
wherein each of the plurality of D/A converters comprises:
a first current generator for generating a plurality of first currents, the plurality of first currents being different from each other; and
a plurality of current sample/hold circuits for respectively storing first voltages corresponding to the first currents in at least two capacitors, and respectively outputting second currents corresponding to the first voltages in response to the grayscale data, and
wherein the D/A converters gather second currents output from the plurality of current sample/hold circuits and output a sum of the second currents as the grayscale current.

14. The grayscale current generator of claim 13, wherein the first current generator generates the plurality of the first currents, each of the first currents corresponding to a bit of the grayscale data.

15. The grayscale current generator of claim 13, further comprising
a shift register for generating a plurality of second signals by sequentially delaying a first signal for a period, and wherein
the second signals are sequentially input to the plurality of D/A converters.

16. The grayscale current generator of claim 15, wherein at least one of the current sample/hold circuits comprises:
first and second transistors, each having first, second and third electrodes, the first and second transistors being cascade-connected to a power source;
first and second switches for respectively diode-connecting the first and second transistors in response to a corresponding one of the second signals;
a third switch for applying the first currents to the first and second transistors in response to the corresponding one of the second signals; and
a fourth switch for holding a corresponding one of the second currents in response to the grayscale data,
wherein the at least two capacitors are respectively coupled between the first electrodes of the first and second transistors and the power source.

17. The grayscale current generator of claim 16, wherein the at least one of the current sample/hold circuits further comprises a current mirror circuit for mirroring a corresponding one of the first currents, and
wherein the third switch transmits a current mirrored by the current mirror circuit to the first and second transistors in response to a corresponding one of the second signals.

18. The grayscale current generator of claim 17, wherein the at least one of the current sample/hold circuits further comprises a diode coupled to the fourth switch.

19. A current sample/hold circuit for sampling and holding a first current, comprising:
first and second transistors, each having first, second and third electrodes, the first and second transistors being cascade-connected to a power source, and diode-connected in response to a first control signal;
first and second capacitors respectively coupled between the first electrodes of the first and second transistors and the power source;
a first switch for applying the first current to the first and second transistors in response to a second control signal; and
a second switch coupled to the third electrode of the second transistor, and for holding a current flowing to the second transistor in response to a third control signal.

20. The current sample/hold circuit of claim 19, further comprising a current mirror circuit for mirroring the first current, wherein the first switch transmits a current mirrored by the current mirror circuit to the first and second transistors.

21. The current sample/hold circuit of claim 20, further comprising a diode coupled to the second switch.

22. A driving method of a display panel having a plurality of pixels for displaying an image corresponding to data currents, the driving method comprising:
generating a plurality of first currents that are different from each other;
sampling the first currents and respectively storing a plurality of first voltages corresponding to the first currents in at least two capacitors;
respectively outputting a plurality of second currents corresponding to the plurality of first voltages in response to grayscale data; and
adding the plurality of second currents and outputting a sum of the second currents as at least one of the data currents.

23. The driving method of claim 22, wherein the outputting of the plurality of second currents outputs the second currents that correspond to the first voltages in response to bits of the grayscale data.

24. The driving method of claim 22, wherein each of the first currents corresponds to one of the bits of the grayscale data, and
wherein a number of the different first currents correspond to a number of the bits in the grayscale data.
